(19) United States
(12) Patent Application Publication
(10) Pub. No.: US 2013/0016053 A1
(43) Pub. Date: Jan. 17, 2013

(54) KEY INPUT DEVICE

(71) Applicant: Byeng Sang JUNG, Suwon-si (KR)

(72) Inventor: Byeng Sang JUNG, Suwon-si (KR)

(73) Assignee: SAMSUNG ELECTRONICS CO. LTD., Suwon-si (KR)

(21) Appl. No.: 13/542,191

(22) Filed: Jul. 5, 2012

(30) Foreign Application Priority Data
Jul. 11, 2011 (KR) 10-2011-0068229

(51) Int. Cl. G06F 3/041; G06F 3/01

(52) U.S. Cl. 345/173; 345/156

(57) ABSTRACT

A key input device is provided. The key input device includes a pressure key having a pressing surface, a pressure sensor formed on an opposite surface side of the pressing surface of the pressure key, a flexible member formed on a side portion of the pressure key, a vibration actuator attached to the flexible member, and a controller for controlling the vibration actuator according to a pressure detected by the pressure sensor, or includes a touch key having a touch surface, a touch sensor formed on an opposite surface side of the touch surface of the touch key, a flexible member formed on a side portion of the touch key, a vibration actuator attached to the flexible member, and a controller for controlling the vibration actuator according to a touch detected by the touch sensor.

### PRIORITY

This application claims the benefit under 35 U.S.C. §119(a) of a Korean patent application filed on Jul. 11, 2011 in the Korean Intellectual Property Office and assigned Serial No. 10-2011-0068229, the entire disclosure of which is hereby incorporated by reference.

### BACKGROUND OF THE INVENTION

1. Field of the Invention

The present invention relates to a key input device. More particularly, the present invention relates to a key input device for an electronic device having a pressure key or a touch key having a haptic function.

2. Description of the Related Art

Recently, with respect to a user input through a touch screen or a key, a haptic function for providing haptic feedback such as vibration has been applied to an electronic device.

FIG. 1 is a cross-sectional view illustrating a key input device according to the related art.

Referring to FIG. 1, the key input device 100 includes a mechanical key input unit 111, a protrusion 112, a hard key 115, and a vibration actuator (not illustrated). The hard key 115 has a pressing surface 115a pressed by the user and is formed with polycarbonate or a metal. A case 102 is positioned at a side portion of the hard key 115. The protrusion 112 is formed on an opposite surface 115b of the pressing surface 115a of the hard key 115 and performs a function of pressing a conductive dome 111a when the user presses the pressing surface 115a in an arrow direction A. The mechanical key input unit 111 includes the conductive dome 111a, a dome terminal 111b formed in an end portion of the conductive dome 111a, and a substrate terminal 111c formed in a substrate 116. The vibration actuator is attached to a display (not illustrated) of an electronic device (not illustrated) having the key input device 100 therein and vibrates according to a key input of the key input device 100.

The key input device 100 provides feedback to the user in a method in which the vibration actuator vibrates the entire electronic device. Accordingly, instead of transferring the vibration to a hand operating the key input device 100, a problem exists in which the vibration is transferred to a hand holding the electronic device. More particularly, in a large-sized electronic device such as a tablet Personal Computer (PC), a laptop PC, or a desktop PC, haptic feedback to a key input is not provided to the user, but is provided to the entire electronic device.

### SUMMARY OF THE INVENTION

Aspects of the present invention are to address the above-mentioned problems and/or disadvantages and to provide at least the advantages described below. Accordingly, an aspect of the present invention is to provide a key input device in which a user can receive accurate feedback when a key is operated using a pressure key or a touch key having a haptic function.

In accordance with an aspect of the present invention, a key input device is provided. The key input device includes a pressure key having a pressing surface, a pressure sensor formed on an opposite surface side of the pressing surface of the pressure key, a flexible member formed on a side portion of the pressure key, a vibration actuator attached to the flexible member, and a controller for controlling the vibration actuator according to a pressure detected by the pressure sensor.

In accordance with another aspect of the present invention, a key input device is provided. The key input device includes a touch key having a touch surface, a touch sensor formed on an opposite surface side of the touch surface of the touch key, a flexible member formed on a side portion of the touch key, a vibration actuator attached to the flexible member, and a controller for controlling the vibration actuator according to a touch detected by the touch sensor.

In accordance with a further aspect of the present invention, a key input device is provided. The key input device includes at least one of a pressure key comprising a pressing surface and a touch key comprising a touched surface, a flexible member formed on a side portion of the at least one of the pressure key and the touch key, a vibration actuator attached to the flexible member formed on a side portion of the at least one of the pressure key and the touch key for vibrating according to at least one of a detected pressure and a detected touch, and a controller for controlling the vibration actuator according to the at least one of the detected pressure and the detected touch.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a cross-sectional view illustrating a key input device according to the related art;

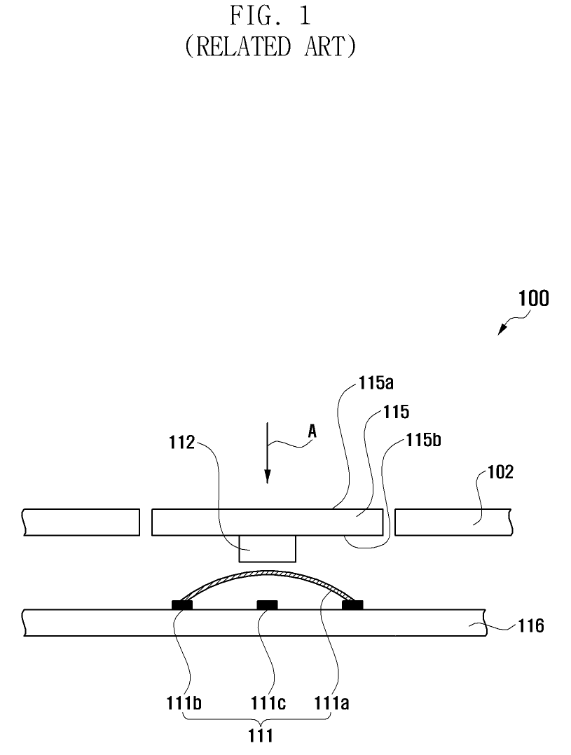

FIG. 2 is a block diagram illustrating a key input device according to an exemplary embodiment of the present invention;

FIG. 3 is a front view illustrating a mobile terminal having a key input device according to an exemplary embodiment of the present invention;

FIG. 4 is a cross-sectional view illustrating a key input device taken along line B-B′ of FIG. 3 according to an exemplary embodiment of the present invention;

FIG. 5 is a cross-sectional view illustrating a key input device according to an exemplary embodiment of the present invention;

FIG. 6 is a cross-sectional view illustrating a key input device according to an exemplary embodiment of the present invention;

FIG. 7 is a front view illustrating a key input device according to an exemplary embodiment of the present invention;

FIG. 8 is a block diagram illustrating a key input device according to an exemplary embodiment of the present invention;

FIG. 9 is a front view illustrating a mobile terminal having a key input device according to an exemplary embodiment of the present invention; and

FIG. 10 is a cross-sectional view illustrating a key input device taken along line G-G′ of FIG. 9 according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, detailed descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

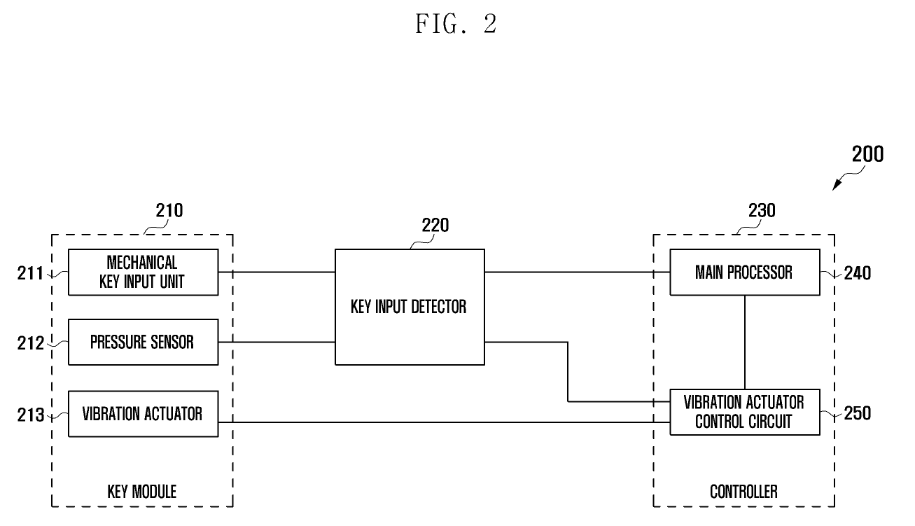

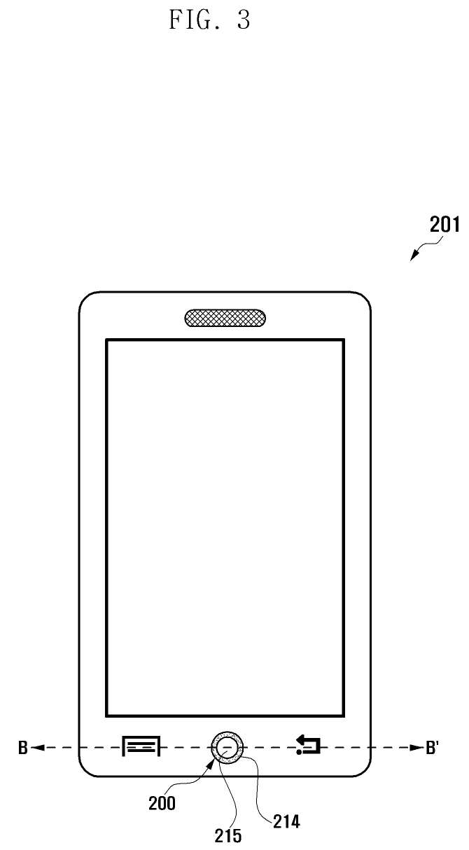

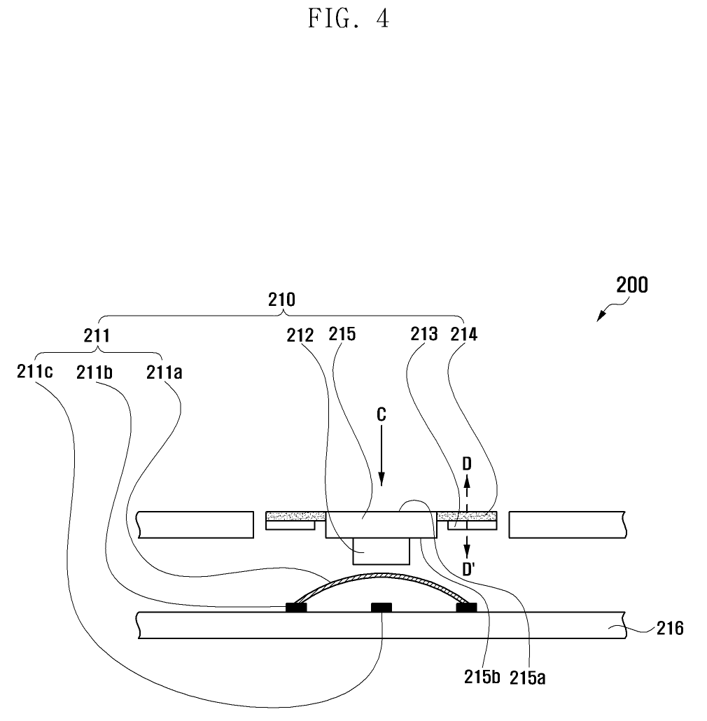

FIG. 2 is a block diagram illustrating a key input device according to an exemplary embodiment of the present invention, FIG. 3 is a front view illustrating a mobile terminal having a key input device according to an exemplary embodiment of the present invention, and FIG. 4 is a cross-sectional view illustrating a key input device taken along line B-B′ of FIG. 3 according to an exemplary embodiment of the present invention. For reference, line B-B′ illustrated in FIG. 3 passes through a key input device 200 in a width direction of a mobile terminal 201.

Referring to FIGS. 2 to 4, the key input device 200 includes a key module 210, a key input detector 220, and a controller 230.

The key module 210 includes a mechanical key input unit 211, a pressure sensor 212, a vibration actuator 213, a flexible member 214, and a pressure key 215. The pressure key 215 has a pressing surface 215a pressed by a user and is formed with a hard material such as polycarbonate or metal. In an exemplary implementation, the pressure key 215 has a circle shape when viewing at the front side, however the shape of the pressure key 215 is not limited thereto. The pressure sensor 212 detects pressure in which the user presses the pressure key 215 and is attached to an opposite surface 215b of a pressing surface 215a of the pressure key 215. The mechanical key input unit 211 includes a conductive dome 211a, a dome terminal 211b formed on an end portion of the conductive dome 211a, and a substrate terminal 211c formed on a substrate 216. When the user presses the pressure key 215 in an arrow direction C, the pressure sensor 212 presses the conductive dome 211a. Accordingly, the pressure sensor 212 detects pressure in which the user presses the pressure key 215. Further, as the conductive dome 211a and the substrate terminal 211c have contact, the dome terminal 211b and the substrate terminal 211c are electrically connected. Accordingly, a mechanical key input is performed.

The vibration actuator 213 vibrates according to pressure detected by the pressure sensor 212 and has a thin film form. The vibration actuator 213 may be formed with a piezo-electric material or an electroactive polymer and is attached to one surface of the flexible member 214. As the vibration actuator 213 vibrates in a thickness direction D-D thereof, the flexible member 214 vibrates in a thickness direction D-D together with the vibration actuator 213 and is attached to the pressure key 215 along a side surface of the pressure key 215, as illustrated in FIGS. 3 and 4. Further, when the user presses the pressure key 215, the flexible member 214 may be formed at a touch position of the user's finger.

The key input detector 220 detects a signal output by inputting from the mechanical key input unit 211 or a signal output by detecting from the pressure sensor 212, generates a key event signal, and outputs the key event signal to a main processor 240 or a vibration actuator control circuit 250. In a case where the key module 210 performs a function of a power key, when power of an electronic device is turned off, the user turns on the electronic device. However, when power is turned off, the main processor 240 does not operate and thus the key input detector 220 outputs a key event signal to the vibration actuator control circuit 250. The key input detector 220 may be formed with an Integrated Circuit (IC).

The controller 230 controls the vibration actuator 213 according to pressure detected by the pressure sensor 212. More specifically, the controller 230 controls the vibration actuator 213 by receiving a key event signal output from the key input detector 220. The controller 230 includes the main processor 240 for receiving a key event signal from the key input detector 220 and controlling the vibration actuator 213, and a vibration actuator control circuit 250 for controlling the vibration actuator 213 according to a key event signal output from the key input detector 220 or a control signal output from the main processor 240. The controller 230 controls to change strength and a pattern of vibration of the vibration actuator 213 according to the magnitude of pressure detected by the pressure sensor 212.

In an exemplary embodiment of the present invention, the vibration actuator 213 vibrating according to pressure detected by the pressure sensor 212 is attached to the flexible member 214 formed on a side portion of the pressure key 215. Accordingly, vibration feedback to a key input can be intensively transferred to a finger operating the pressure key 215.

Further, because only the side portion of the pressure key 215 instead of an entire electronic device having the key input device 200 therein vibrates, by applying the key input device 200 to even a large-sized electronic device such as a tablet PC, a laptop PC, or a desktop PC, haptic feedback to a key input can be transferred to the user.

Further, the pressure sensor 212 and the vibration actuator 213 are separately positioned by the pressure key 215 formed with a hard material. Accordingly, the pressure sensor 212 can accurately detect pressure without having an influence on the vibration of the vibration actuator 213.

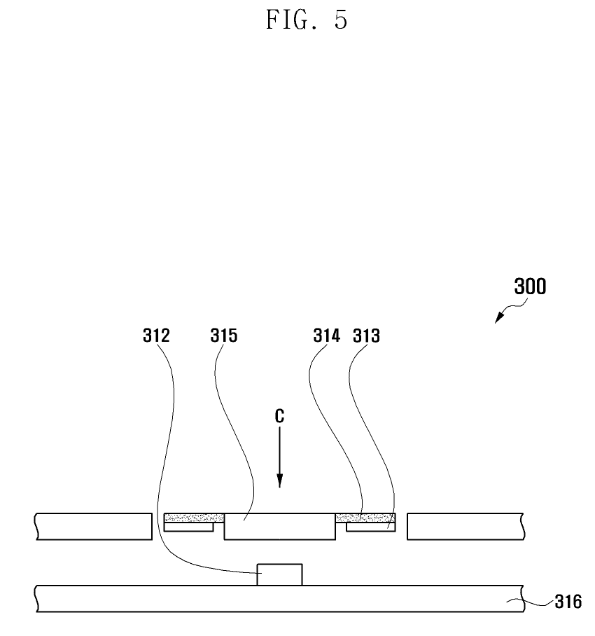

FIG. 5 is a cross-sectional view illustrating a key input device according to an exemplary embodiment of the present invention.

Referring to FIG. 5, the key input device 300 according to an exemplary embodiment of the present invention is described. The key input device 300 does not have a mechanical key input unit 211, as illustrated in FIG. 4. The key input device 300 includes a pressure sensor 312 that is mounted on a substrate 316, instead of being attached to a pressure key 315. The key input device 300 has the same configuration as that illustrated in FIG. 4, except for the above described configuration. When the pressure key 315 is pressed in an arrow direction C, pressure applied to the pressure key 315 by the pressure sensor 312 is detected. According to the pressure, a vibration actuator 313 and a flexible member 314 vibrate.

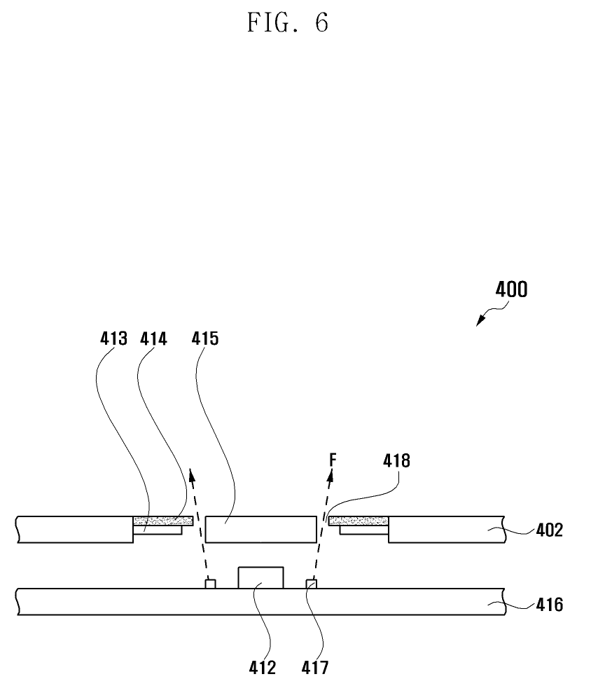

FIG. 6 is a cross-sectional view illustrating a key input device according to an exemplary embodiment of the present invention.

Referring to FIG. 6, the key input device 400 includes a Light Emitting Diode (LED) 417 positioned at the periphery of a pressure sensor 412 that is mounted in a substrate 416, unlike the key input device 300 illustrated in FIG. 5. The key input device 400 also includes a vibration actuator 413 and a flexible member 414 that are attached to a case 402 separately from a pressure key 415. The key input device 400 has the same configuration as that illustrated in FIG. 5, except for the above described configuration. When the pressure sensor 412 detects pressure applied to the pressure key 415, the LED 417 emits light. The emitted LED light is transferred to the user by passing through a gap 418 between the pressure key 415 and the flexible member 414 in an arrow direction F. Further, the vibration actuator 413 and the flexible member 414 vibrate.

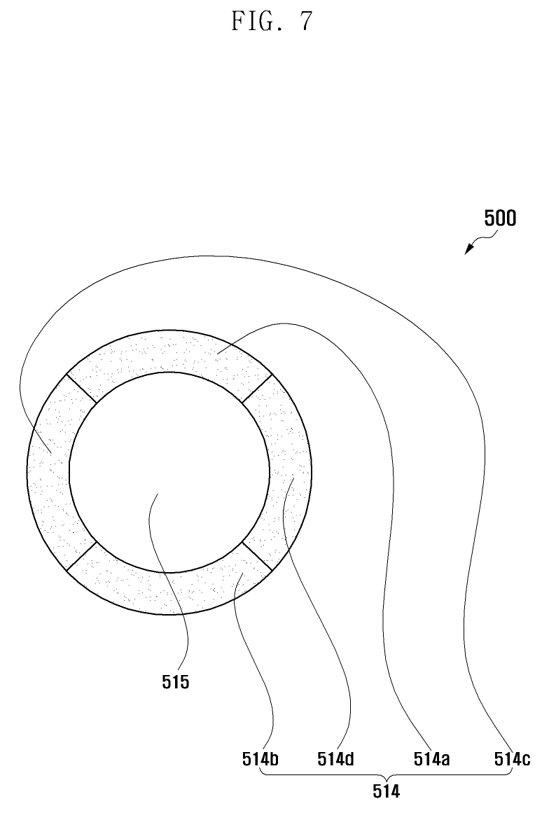

FIG. 7 is a front view illustrating a key input device according to an exemplary embodiment of the present invention.

Referring to FIG. 7, in the key input device 500, a flexible member 514 includes an upper flexible member 514a, a lower flexible member 514b, a left flexible member 514c, and a right flexible member 514d, unlike the key input device 200 illustrated in FIG. 3. Further, a separate vibration actuator (not illustrated) is attached to each of the upper, lower, left, and right flexible members 514a, 514b, 514c, and 514d. That is, the vibration actuator is formed as a plurality of vibration actuators corresponding to a direction of a pressure key 515. Further, a pressure sensor (not illustrated) attached to the pressure key 515 can detect a direction. The key input device 500 has the same configuration as that illustrated in FIGS. 3 and 4, except for the above described configuration. The plurality of vibration actuators selectively vibrate according to a direction of pressure applied to the pressure key 515. Accordingly, the upper flexible member 514a vibrates when the user presses the upper side of the pressure key 515, the lower flexible member 514b vibrates when the user presses the lower side of the pressure key 515, the left flexible member 514c vibrates when the user presses the left side of the pressure key 515, and the right flexible member 514d vibrates when the user presses the right side of the pressure key 515.

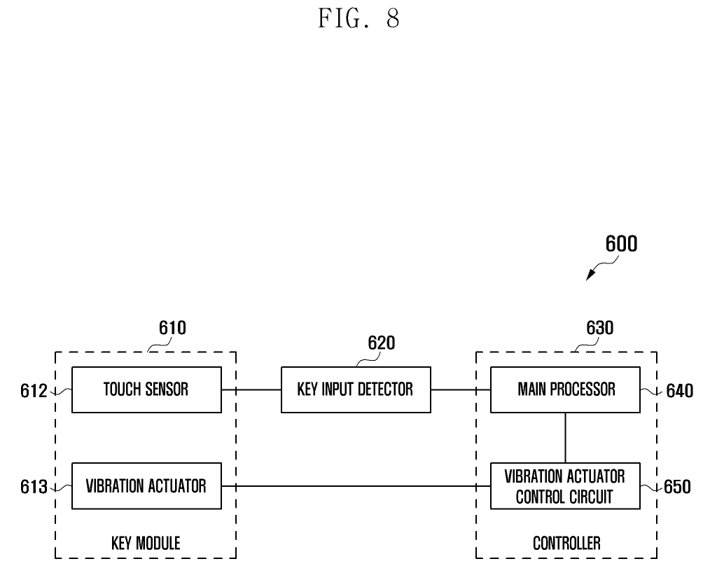

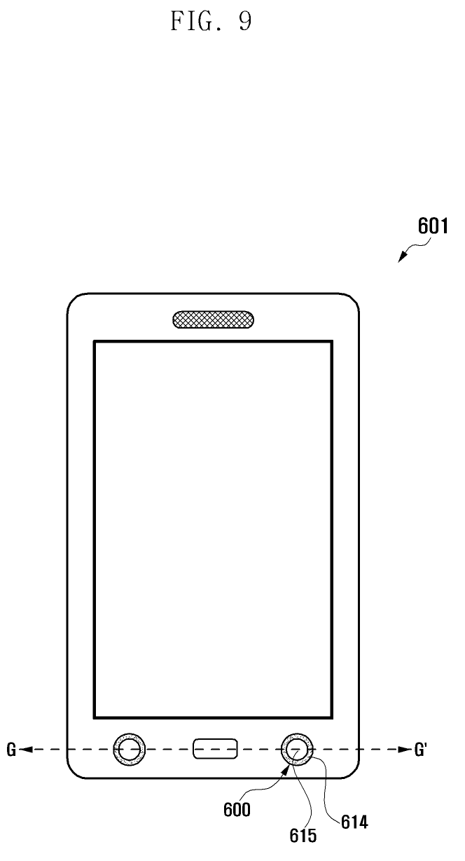

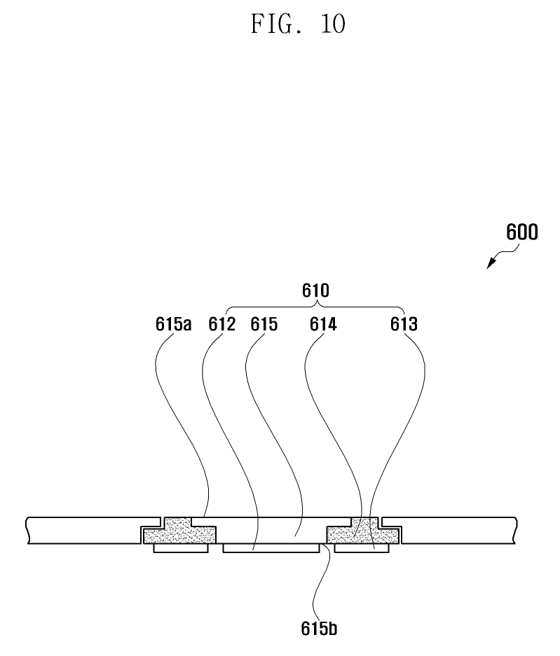

FIG. 8 is a block diagram illustrating a key input device according to an exemplary embodiment of the present invention, FIG. 9 is a front view illustrating a mobile terminal having a key input device according to an exemplary embodiment of the present invention, and FIG. 10 is a cross-sectional view illustrating a key input device taken along line G-G′ of FIG. 9 according to an exemplary embodiment of the present invention. For reference, line G-G′ illustrated in FIG. 9 passes through a key input device 600 in a width direction of a mobile terminal 601.

Referring to FIGS. 8 to 10, the key input device 600 includes a key module 610, a key input detector 620, and a controller 630.

The key module 610 includes a touch sensor 612, a vibration actuator 613, a flexible member 614, and a touch key 615. The touch key 615 has a touch surface touched by the user and is formed with glass or polycarbonate. The touch sensor 612 detects a user's touch to the touch key 615 and is formed on an opposite surface 615a side of a touch surface 615b of the touch key 615. In an exemplary implementation, the touch sensor 612 is attached to the opposite surface 615a, but may be separately disposed from the opposite surface 615b. The vibration actuator 613 is attached to one surface of the flexible member 614 and the flexible member 614 is formed in a side portion of the touch key 615. When the user touches the touch key 615, the flexible member 614 may be formed at a touch position of the user's finger.

The key input detector 620 detects a signal output from the touch sensor 612, generates a key event signal, and outputs the key event signal to a main processor 640. The controller 630 controls the vibration actuator 613 according to a touch detected by the touch sensor 612 and includes the main processor 640 and a vibration actuator control circuit 650. The controller 630 controls to change strength and a pattern of vibration of the vibration actuator 613 according to the user's touch time period detected by the touch sensor 612.

In an exemplary embodiment of the present invention, the vibration actuator 613 vibrating according to a touch time period detected by the touch sensor 612 is attached to the flexible member 614 formed on a side portion of the touch key 615. Accordingly, vibration feedback to a key input can be intensively transferred to a finger operating the touch key 615.

As described above, according to exemplary embodiments of the present invention, a key input device includes a flexible member formed on a side portion of a pressure key or a touch key and a vibration actuator attached to the flexible member, and thus vibration feedback to a key input can be intensively transferred to a user's hand operating the key.

Further, even in a large-sized electronic device such as a tablet PC, a laptop PC, or a desktop PC, haptic feedback to a key input can be effectively transferred to the user.

While the invention has been shown and described with references to certain exemplary embodiments thereof, it will be understood that various changes in form and details may be made therein without departing from the spirit and scope of the invention as defined in the appended claims and their equivalents.

What is claimed is:

1. A key input device comprising:
a pressure key comprising a pressing surface;
a pressure sensor formed on an opposite surface side of the pressing surface of the pressure key;
a flexible member formed on a side portion of the pressure key;
a vibration actuator attached to the flexible member; and
a controller for controlling the vibration actuator according to a pressure detected by the pressure sensor.

2. The key input device of claim 1, wherein the controller changes at least one of strength and a pattern of vibration of the vibration actuator according to a magnitude of the pressure detected by the pressure sensor.

3. The key input device of claim 1, wherein the vibration actuator is formed as a plurality of vibration actuators corresponding to a direction of the pressure key.

4. The key input device of claim 3, wherein the plurality of vibration actuators selectively vibrate according to a direction of the pressure applied to the pressure key.

5. The key input device of claim 1, wherein the pressure key is formed with a hard material.

6. The key input device of claim 1, wherein the pressure sensor is mounted on a substrate opposite to the opposite surface of the pressing surface.

7. A key input device comprising:
a touch key comprising a touch surface;
a touch sensor formed on an opposite surface side of the touch surface of the touch key;
a flexible member formed on a side portion of the touch key;
a vibration actuator attached to the flexible member; and
a controller for controlling the vibration actuator according to a touch detected by the touch sensor.

8. The key input device of claim 7, wherein the controller changes strength and a pattern of vibration of the vibration actuator according to a touch time period detected by the touch sensor.

9. A key input device comprising:
at least one of a pressure key comprising a pressing surface and a touch key comprising a touched surface;
a flexible member formed on a side portion of the at least one of the pressure key and the touch key;
a vibration actuator attached to the flexible member formed on a side portion of the at least one of the pressure key and the touch key for vibrating according to at least one of a detected pressure and a detected touch; and
a controller for controlling the vibration actuator according to the at least one of the detected pressure and the detected touch.

10. The key input device of claim 9, wherein the controller changes at least one of strength and a pattern of vibration of the vibration actuator according to at least one of a touch time period detected by a touch sensor and a magnitude of a pressure detected by a pressure sensor.

11. The key input device of claim 10, wherein the touch sensor is formed on an opposite side of the touch surface of the touch key.

12. The key input device of claim 10, wherein the pressure sensor is formed on an opposite surface side of the pressing surface of the pressure key.

13. The key input device of claim 9, wherein the vibration actuator is formed as a plurality of vibration actuators corresponding to a direction of the pressure key.

14. The key input device of claim 13, wherein the plurality of vibration actuators selectively vibrate according to a direction of pressure applied to the pressure key.

15. The key input device of claim 9, wherein the pressure key is formed with a hard material.

16. The key input device of claim 10, wherein the pressure sensor is mounted on a substrate opposite to an opposite surface of the pressing surface.
